(19) United States
(12) Patent Application Publication
(10) Pub. No.: US 2012/0180405 A1
(43) Pub. Date: Jul. 19, 2012

(54) GEODESIC DOME CONNECTOR

(76) Inventor: Arthur W. DRAKE, Boulder, CO (US)

(21) Appl. No.: 13/219,437

(22) Filed: Aug. 26, 2011

Related U.S. Application Data
(60) Provisional application No. 61/433,877, filed on Jan. 18, 2011.

(51) Int. Cl. E04B 7/10; B41B 11/38; E04B 7/08

(52) U.S. Cl. 52/81.3; 52/745.07; 249/168

(57) ABSTRACT

A connector for a geodesic dome comprises a first coupler, a second coupler, and a third coupler. Each coupler is configured to couple with a segment, which may be a substantially straight segment. Each coupler is placed at an angle with respect to the other two couplers and with a horizontal plane, such that a geodesic dome may be constructed using a plurality of the same connectors and a plurality of the same segments.

### CROSS-REFERENCE TO RELATED APPLICATIONS

This application claims the benefit of U.S. Provisional Application Ser. No. 61/433,877, filed on Jan. 18, 2011, which is incorporated herein by reference in its entirety for all purposes.

### TECHNICAL FIELD

Various embodiments of the present invention relate generally to geodesic structures. More specifically, embodiments of the present invention relate to connectors for constructing geodesic domes.

### BACKGROUND

Geodesic structures, such as geodesic domes, include curved objects formed from a lattice of flat polygons. For example, truncated icosahedrons have spherical shapes formed from twelve flat pentagon faces and twenty flat hexagon faces. When assembled, truncated icosahedrons have sixty vertices and ninety edges. No matter what polygons are used, in order to form a geodesic dome each polygon must be placed at an angle with respect to adjoining polygons. Thus, forming a geodesic structure involves not only arranging straight segments to form the edges of the flat polygons, but also joining various polygons at particular angles. For geodesic structures in which a single straight segment serves as a shared side for two adjacent polygons, a connector may be used to arrange the straight segments into the geodesic configuration.

### SUMMARY

According to embodiments of the present invention, a connector comprises three couplers, with each coupler configured to receive one end of a straight segment or chord. The connector is configured such that a geodesic dome may be constructed using a plurality of identical connectors and a plurality of identical segments. The connector may also include one or more apertures to decrease the weight of the geodesic dome.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a perspective view of a geodesic dome according to embodiments of the present invention.

FIG. 2 is an upper perspective view of a connector according to embodiments of the present invention.

FIG. 3 is a lower perspective view of the connector of FIG. 2.

FIG. 4 is a cut-away perspective view of the connector of FIG. 2.

FIG. 5 is an upper perspective view of a connector according to embodiments of the present invention.

FIG. 6 is a lower perspective view of the connector of FIG. 5.

FIG. 7 is a cut-away perspective view of the connector of FIG. 5.

FIG. 8 is an upper cut-away perspective view of a connector according to embodiments of the present invention.

FIG. 9 is an enlarged perspective view of the geodesic dome of FIG. 1.

FIG. 10 is a top view of a connector according to embodiments of the present invention.

FIG. 11 is a front view of the connector of FIG. 10.

FIG. 12 is a side view of the connector of FIG. 10.

FIG. 13 is an opposite side view of the connector of FIG. 10.

FIG. 14 is a unit vector diagram of the connector of FIG. 10.

FIG. 15 is a top view of a connector according to embodiments of the present invention

FIG. 16 is a side view of the connector of FIG. 15.

FIG. 17 is an enlarged perspective view of a geodesic dome according to embodiments of the present invention.

FIG. 18 is a bottom view of the connector of FIG. 15.

FIG. 19 is a side cut-away view of the connector of FIG. 15 along the line E-E of FIG. 18.

FIG. 20 is an upper cut-away view of the connector of FIG. 15 along the line H-H in FIG. 16.

FIG. 21 is an upper view of the connector of FIG. 15 along the line C-C in FIG. 16.

FIG. 22 is a bottom view of the connector of FIG. 15.

FIG. 23 is a side view of the connector of FIG. 15 along the axial centerline of a first coupler.

FIG. 24 is a side cut-away view of the connector of FIG. 15 along the line F-F of FIG. 18.

FIG. 25 is an upper view of the connector of FIG. 15.

FIG. 26 is an upper perspective view of the connector of FIG. 15.

FIG. 27 is a lower perspective view of the connector of FIG. 15.

FIG. 28 is a side cut-away view of the connector of FIG. 15 along the line D-D of FIG. 23.

FIG. 29 is a side cut-away view of the connector of FIG. 15 along the line B-B of FIG. 23.

FIG. 30 is an enlarged side view of an intersection of the connector of FIG. 15 as noted in FIG. 29.

FIG. 31 is an exploded view of a mold and a connector, according to embodiments of the present invention.

FIG. 32 is a perspective view of the assembled mold of FIG. 31.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

According to some embodiments of the invention, a connector may comprise multiple couplers that are joined together by a midpiece. The couplers are placed in a specific configuration such that a geodesic dome or structure may be constructed using a plurality of substantially identical connectors and a plurality of substantially identical straight segments. Those embodiments facilitate the construction of a geodesic dome because a geodesic dome may be constructed with as few as two basic types of components: a connector and a straight segment. In addition, the volume enclosed by the geodesic dome may be changed simply by altering the length of the straight segments.

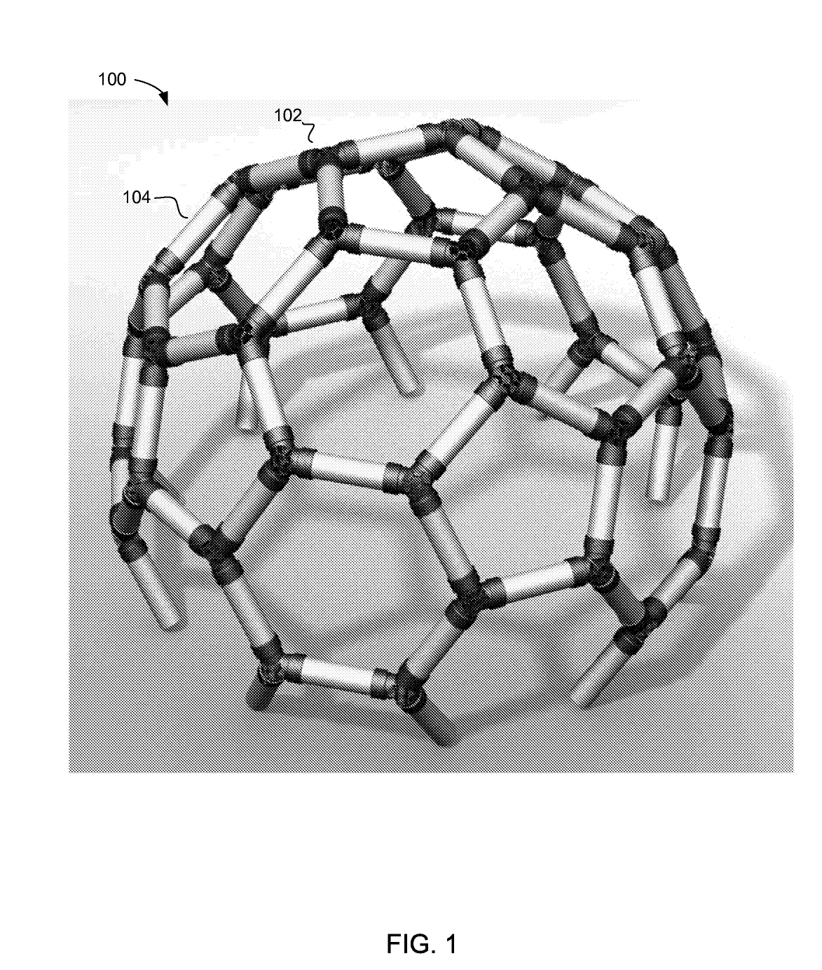

In the embodiment shown in FIG. 1, a geodesic dome 100 comprises a plurality of connectors 102 and straight segments 104. The straight segments 104 may also be referred to as segments or chords. The dimensions of each straight segment 104 may be substantially identical. For example, each straight segment 104 may be approximately twelve inches in length. In some embodiments, the straight segments 104 may be formed from extruded tubes. In other embodiments, the diameter or shape of the straight segments 104 may vary according to specific applications, and the connectors 102 are similarly altered so that the straight segments 104 may be secured to the connectors 102. As shown in FIG. 1, the geodesic dome 100 may include a shape other than a completed sphere. In addition, the length of the straight segments 104 forming the lowest level of the geodesic dome may be shortened or otherwise altered or adapted to suit various uses.

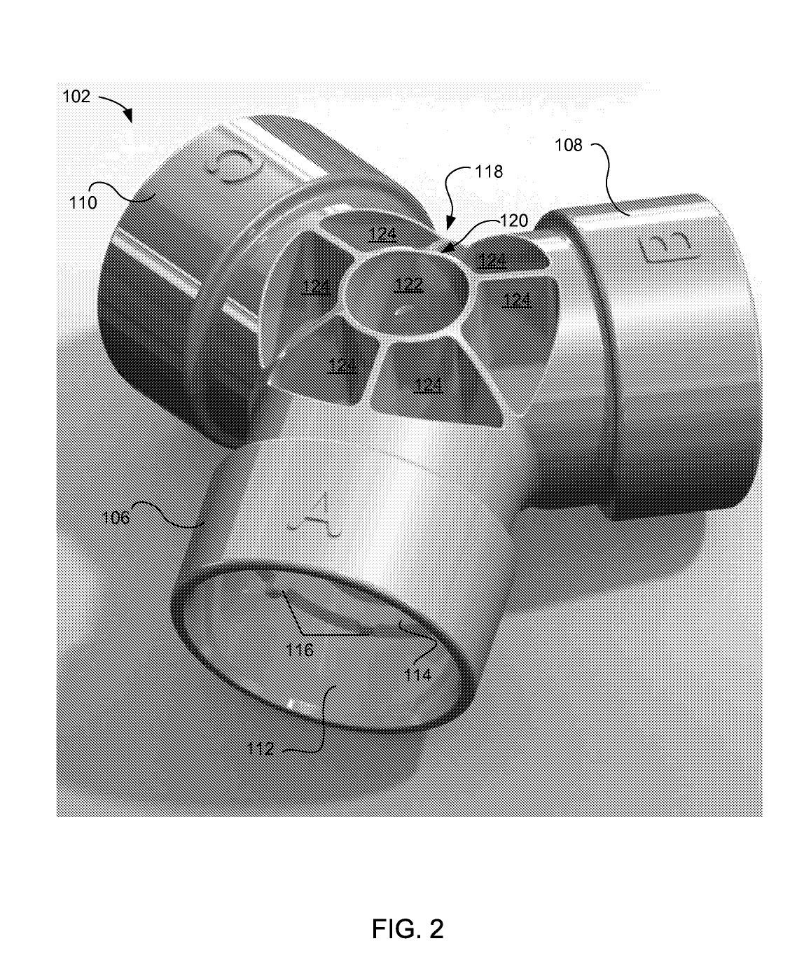

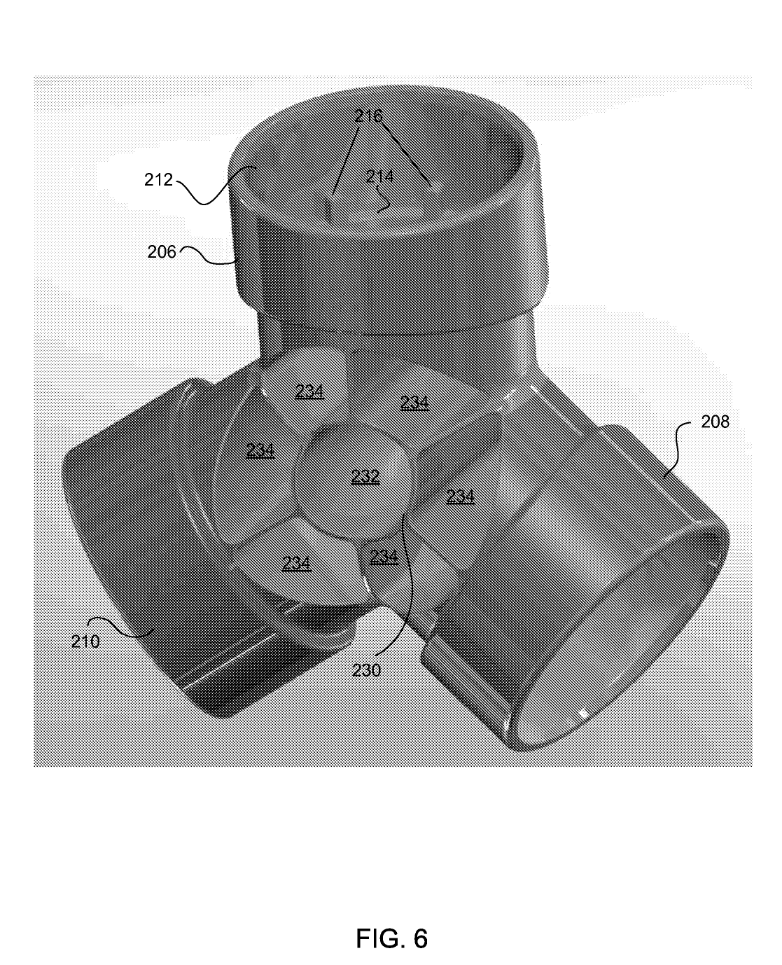

Each connector 102 of the geodesic dome 100 may be substantially identical, and FIGS. 2-16 illustrate various embodiments of those connectors. Connector 102 includes a first coupler 106, a second coupler 108, and a third coupler 110. The first coupler 106 may also be referred to as coupler A, the second coupler 108 may also be referred to as coupler B, and the third coupler 110 may also be referred to as coupler C. Each coupler comprises a coupling aperture 112 configured to receive an end of a straight segment 104. To help secure the straight segment 104, each coupler may comprise a coupling ring 114 having one or more coupling protrusions 116. In some embodiments, the coupling protrusion 116 is a depth stop that ensures uniform length of the straight segments. The coupling protrusion 116 may also afford room for contaminants in the glue (if glue or adhesive is used to join the segments to the coupler) or irregularities on the cut end of the straight segments to be included without changing the intended geometry. In other embodiments, the couplers 106, 108, 110 may comprise simple apertures or may be configured to be secured to straight segments 104 using slip joints or other attachment mechanisms.

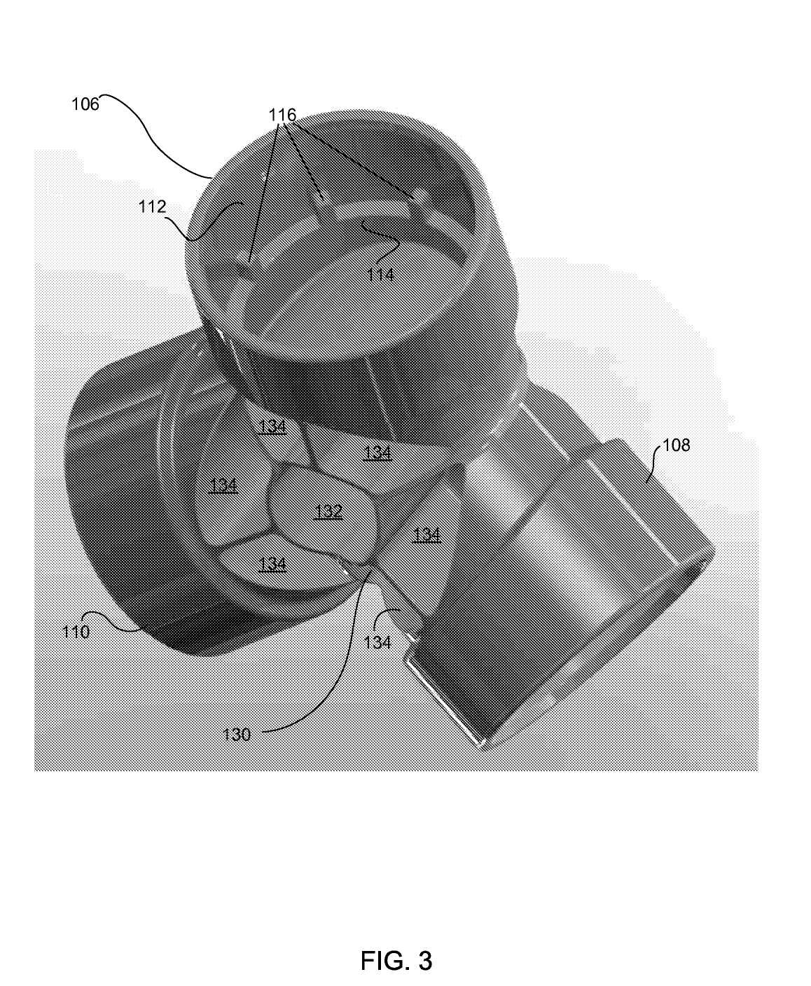

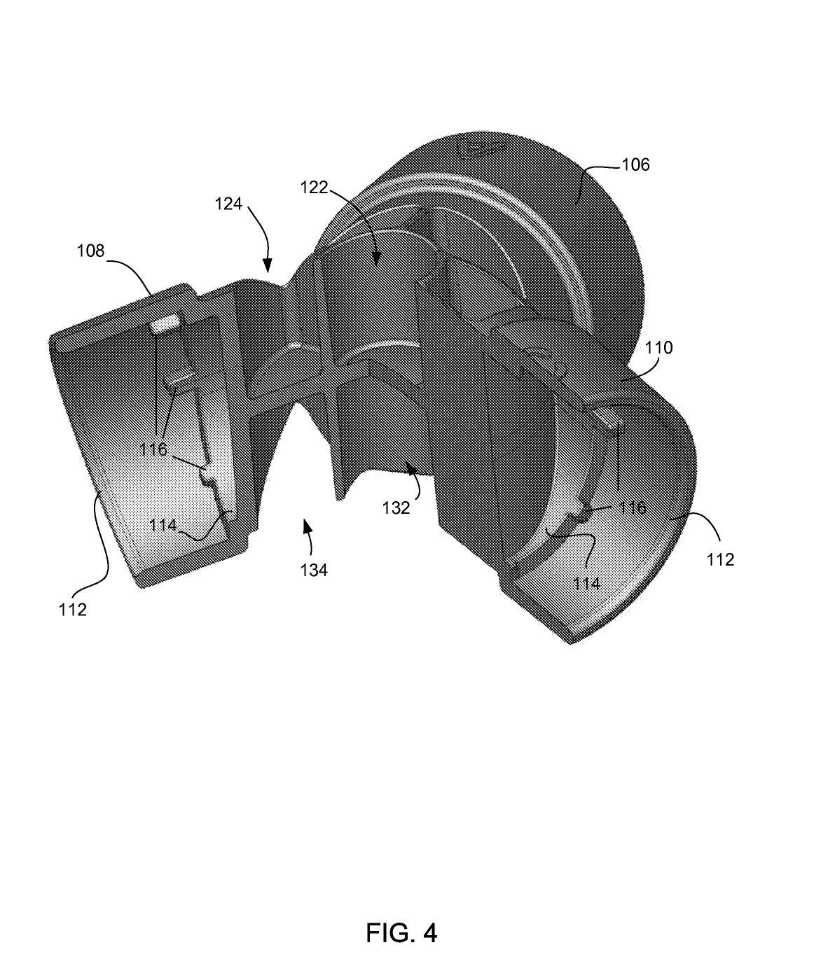

The first coupler 106, the second coupler 108, and the third coupler 110 are each connected to a midpiece 118. According to several embodiments, the midpiece 118 may include one or more apertures in order to decrease the overall weight of the geodesic dome 100. An upper surface 120 of the midpiece 118 includes an upper center midpiece aperture 122 and one or more upper side midpiece apertures 124. For example, the midpiece may have one upper center midpiece aperture 122 and six upper side midpiece apertures 124. As shown in FIG. 3, a lower surface 130 of the midpiece 118 may also comprise one or more apertures. For example, the lower surface 130 may include one lower center midpiece aperture 132 and six lower side midpiece apertures 134. In some embodiments, the dimensions of the upper center midpiece aperture 122 and the lower center midpiece aperture 132 are approximately equal, and the dimensions of the upper side apertures 124 and the lower side apertures 134 are approximately equal. For example, as shown in FIG. 4, the volume of the upper center midpiece aperture 122 is approximately equal to the volume of the lower center midpiece aperture 132. Similarly, the volume of the upper side midpiece aperture 124 is approximately equal to the volume of the lower side midpiece aperture 134.

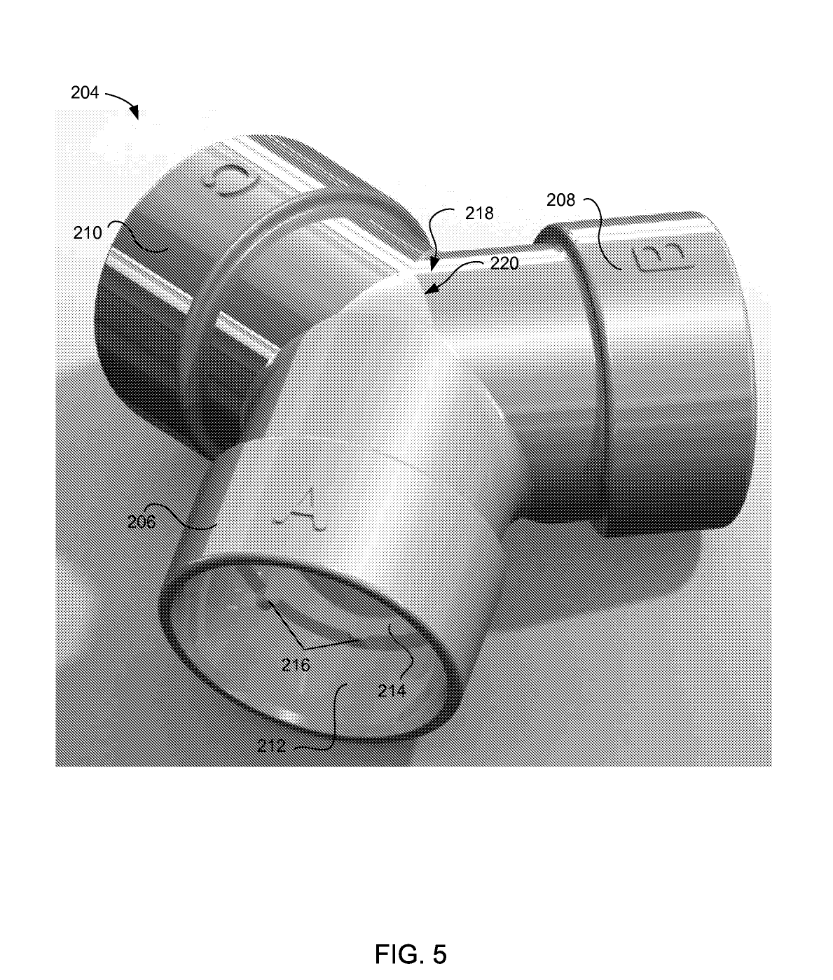

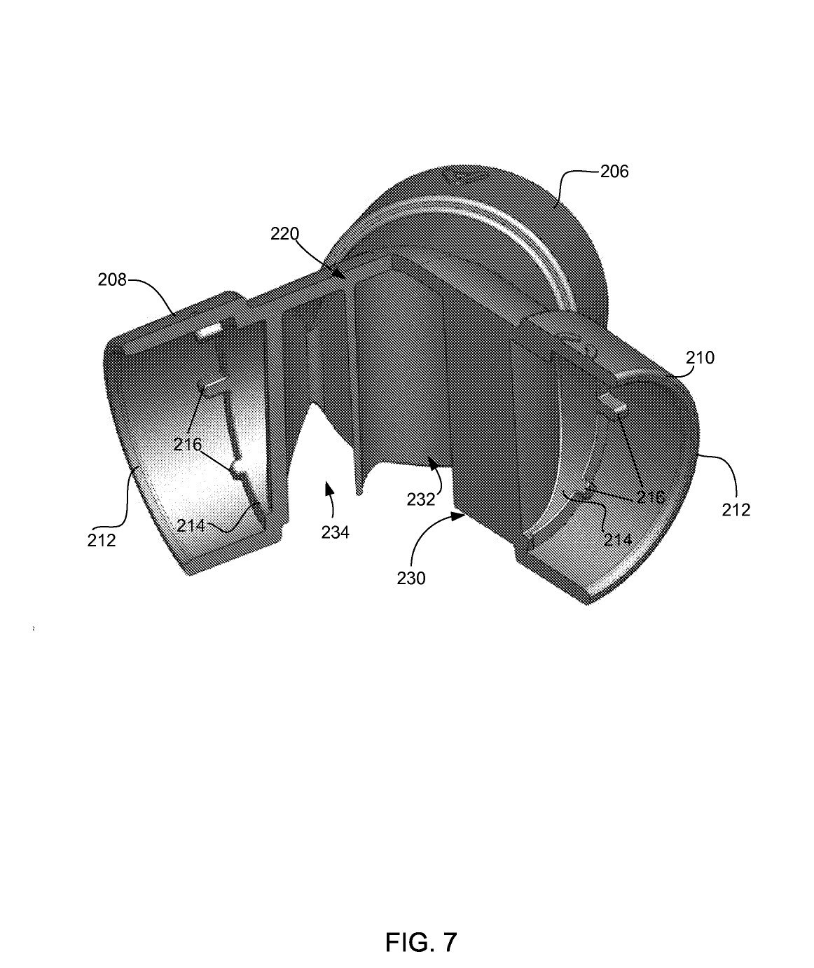

While the volume of each side midpiece aperture 124, 134 may be uniform, in other embodiments the center midpiece apertures 122, 132 or side midpiece apertures 124, 134 may vary in size and shape. In addition, the connector 102 may have apertures on only one surface. For example, in the embodiment shown in FIGS. 5-7, the upper midpiece surface 220 is solid and the lower midpiece surface 230 comprises a lower center midpiece aperture 232 and six lower side midpiece apertures 234. As shown in FIG. 7, the lower center midpiece aperture 232 and the lower side midpiece aperture 234 begin at the lower midpiece surface 230 and reach the upper midpiece surface 220. In other embodiments, the lower center midpiece aperture or the lower side midpiece aperture may pierce the upper midpiece surface 220 to form an open channel between the upper midpiece surface 220 and the lower midpiece surface 230.

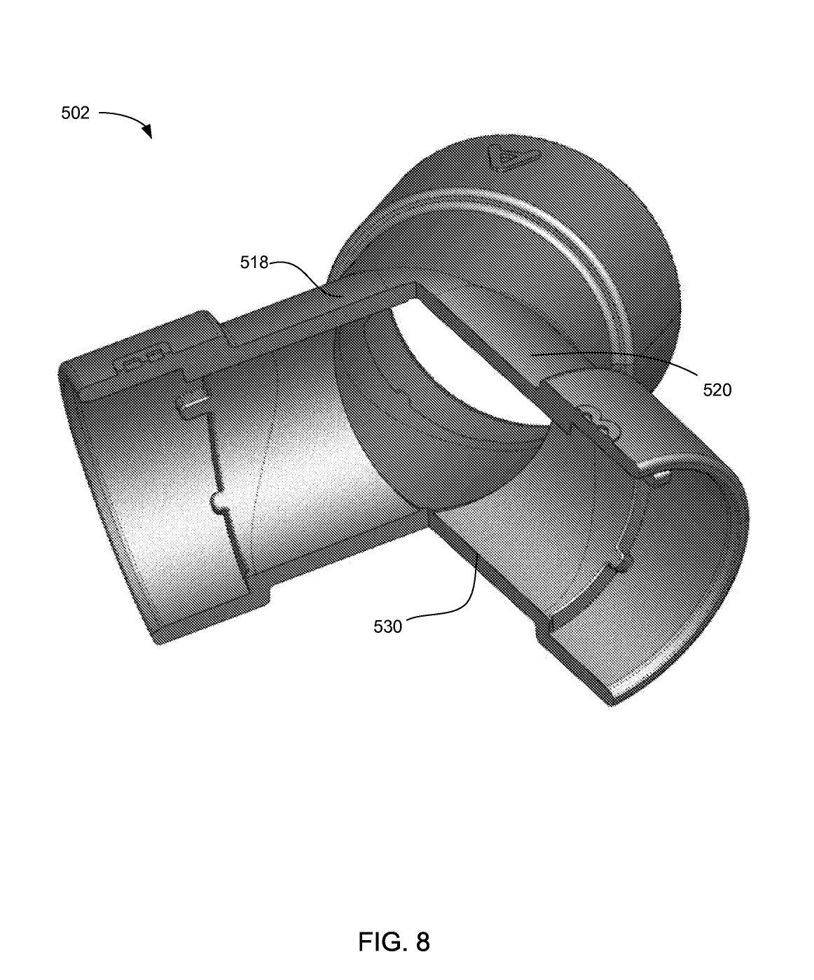

In other embodiments, the midpiece 118 may be hollow and formed without any midpiece apertures. For example, as shown in FIG. 8, the midpiece 518 has a solid upper surface 520 and a solid lower surface 530. As discussed in more detail below, having a hollow midpiece 518 permits a user to place cables, wires, or other material through the connector 502. In other embodiments the midpiece 518 comprises one or more hollow channels.

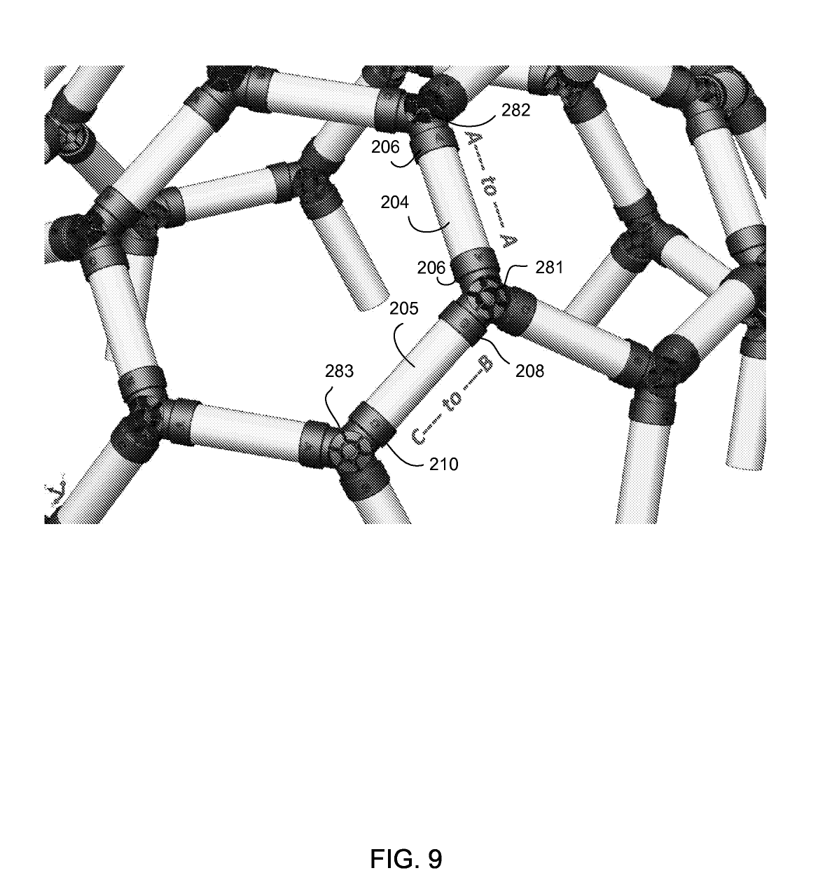

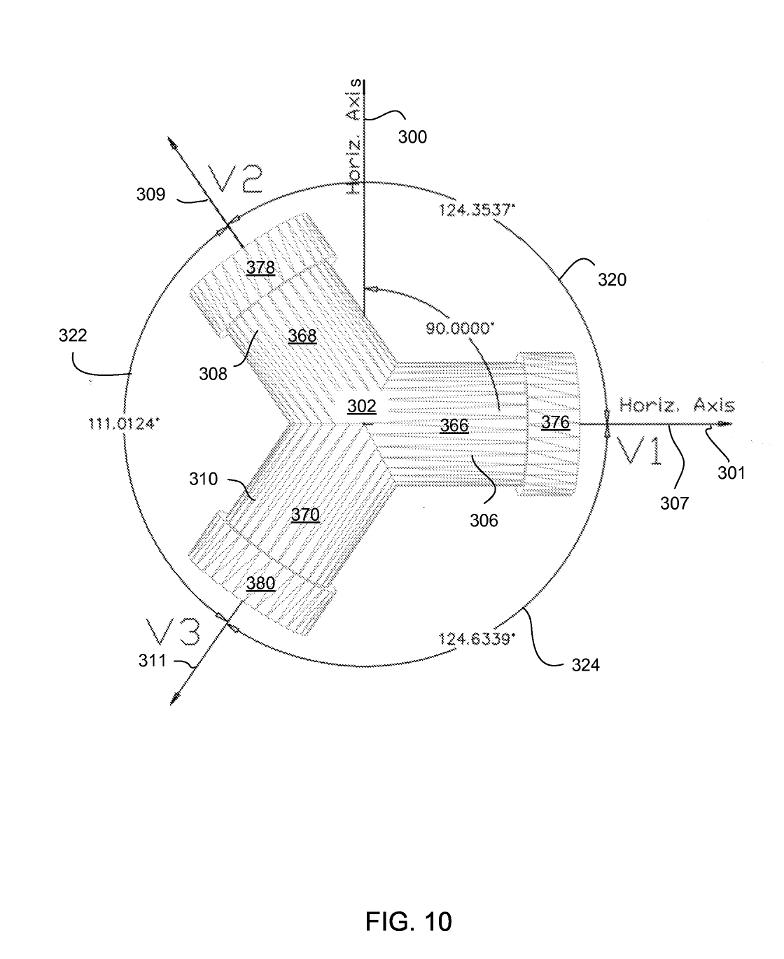

While the number and configuration of each midpiece aperture allows for geodesic domes of varying weight and strength, the configuration of the first coupler, the second coupler, and third coupler, as well as the angular relationship between each coupler, permit the construction of a geodesic dome using substantially identical connectors and substantially identical straight segments. As shown in FIG. 9, a first connector 281 includes a first coupler 206, also referred to as coupler A, which secures the first connector 281 to one end of a first straight segment 204. The other end of the first straight segment 204 is secured to the first coupler 206 on a second connector 282. This results in a coupler-A-to-coupler-A link. One end of a second segment 205 is secured to the first connector 281 by a second coupler 208, also referred to as coupler B. The other end of the second segment 205 is secured to a third connector 283 by a third coupler 210, also known as coupler C. This results in a coupler-C-to-coupler-B link. When constructing the geodesic dome, each connector and each segment are secured using those two links to form a geodesic structure. In some embodiments, the connectors and segments are configured such that a geodesic dome may be constructed using identical or similar connectors and identical or similar segments. The exemplary embodiments shown in FIGS. 10-14 describe connectors that are arranged to achieve such a result.

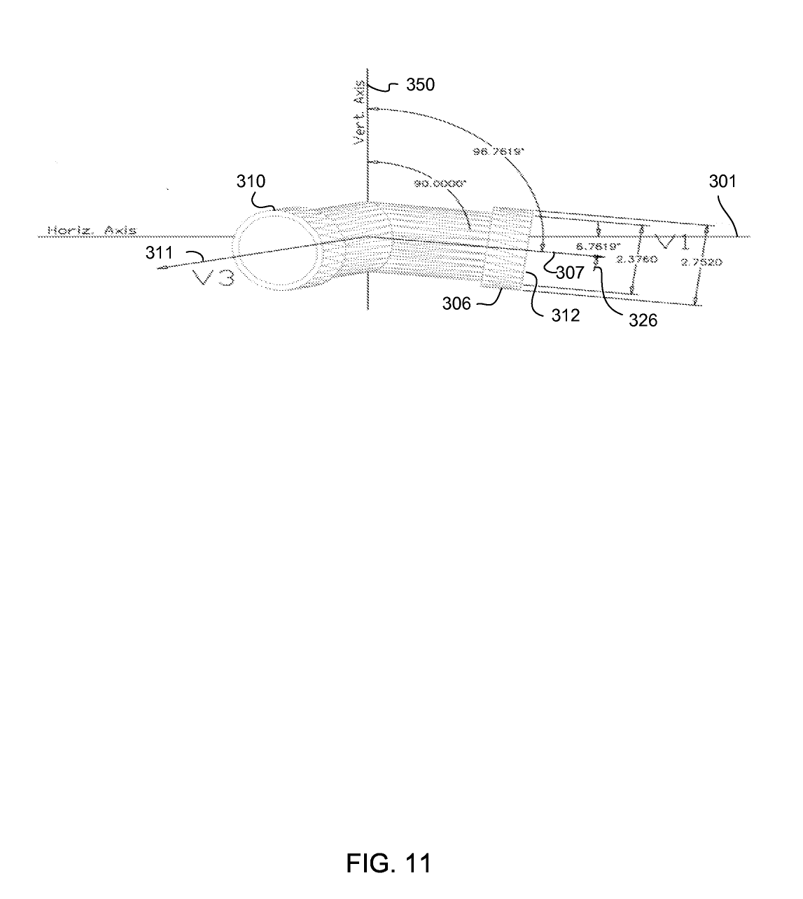

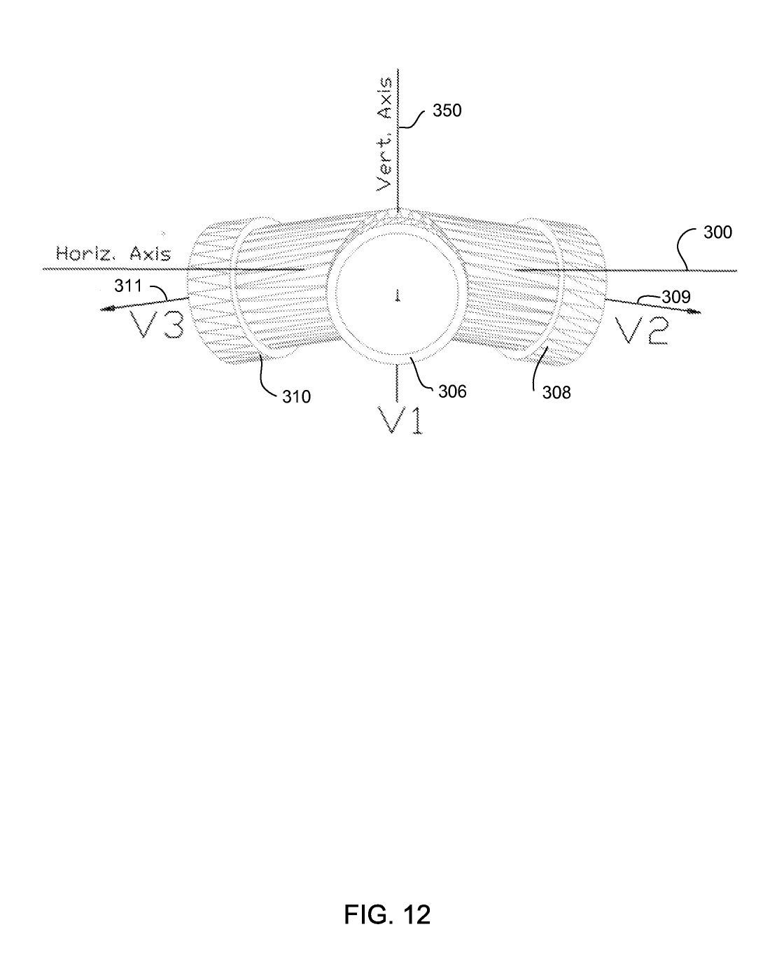

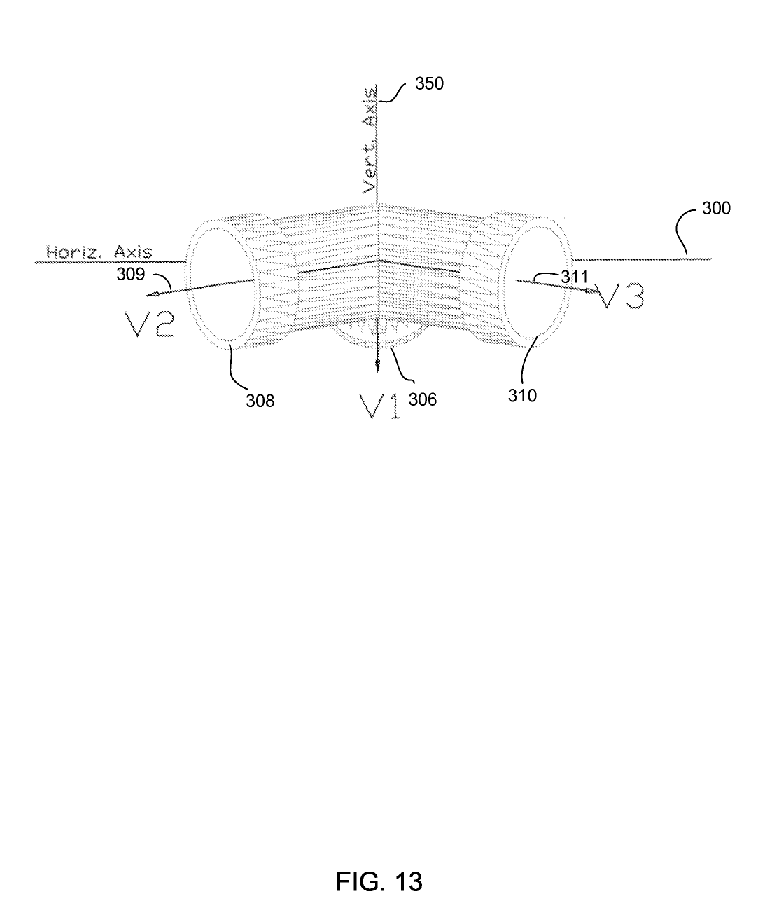

In FIG. 10, a horizontal plane is defined by two orthogonal horizontal axes 300, 301. The view of FIG. 10 is taken along a vertical axis 350 which is substantially orthogonal to the horizontal axes 300, 301. A connector 302 includes a first coupler 306, a second coupler 308, and a third coupler 310. Each coupler 306, 308, 310 is substantially cylindrical or tubular, according to embodiments of the present invention. Vector V1 307 is illustrated as extending from first coupler 306, such that vector V1 307 is substantially aligned with an axial centerline of the first coupler 306. Vector V2 309 is illustrated as extending from second coupler 308, such that vector V2 309 is substantially aligned with an axial centerline of the second coupler 308. Vector V3 311 is illustrated as extending from third coupler 306, such that vector V3 311 is substantially aligned with an axial centerline of the third coupler 306. The view of FIG. 11 is taken along horizontal axis 300, and the views of FIGS. 12 and 13 are taken along horizontal axis 301. While vectors 307, 309, 311 each correspond to their respective couplers in FIGS. 10-13, the horizontal axes 300, 301 are chosen arbitrarily (e.g. any other two axes in the horizontal plane may be used), but the positions of axes 300, 301 are shown consistently in FIGS. 10-13 for ease of understanding and comparison among the views. In the embodiment shown in FIG. 10, the angle 320 between vector V1 307 and vector V2 309, as measured in the horizontal plane, is 124.3537 degrees. The angle 322 between vector V2 309 and vector V3 311, as measured in the horizontal plane is 111.0124 degrees. The angle 324 between vector V1 307 and vector V3 311 is 124.6339 degrees. According to other embodiments of the present invention, angle 322 is approximately 111 degrees and angles 320, 324 are each approximately 124.5 degrees. According to yet other embodiments of the present invention, angle 322 is approximately 111.2927 degrees and angles 320, 324 are each approximately 124.35365 degrees.

FIG. 11 depicts the connector 302 in a view taken along horizontal axis 300, where the coupling aperture 312 of coupler 306 may have a diameter of 2.3760 inches. The outer diameter of the coupler 306 may be 2.7520 inches. Each coupler 306, 308, and 310 includes a main portion 366, 368, 370 that is co-axial with an outer sleeve portion 376, 378, 380. Each outer sleeve portion 376, 368, 370 may be configured to receive an end of a straight segment 104. As described in more detail below, the size and shape of each coupler 306, 308, 310 may be modified to secure straight segments of varying sizes and shapes.

FIG. 11 also illustrates that each coupler is placed at an angle with respect to the horizontal axis 301. For example, an angle 326 between vector V1 and the horizontal plane formed by horizontal axes 300, 301 may be 6.7619 degrees. FIGS. 12 and 13 show a similar relationship between the vector V2 309 and the horizontal plane, as well as between vector V3 311 and the horizontal plane. In other embodiments, the angle between each vector 307, 309, and 311 and the horizontal plane is approximately 6.76 degrees.

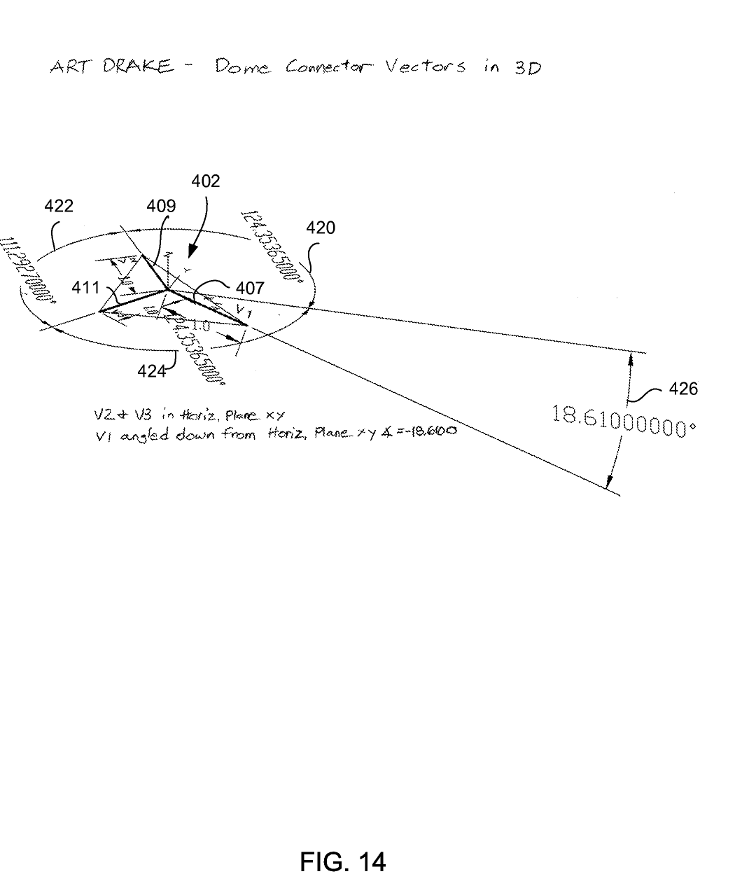

FIG. 14 illustrates the configuration of a connector 402 in unit vector form. The center of coupler 406 is depicted by vector V1 407, the center of coupler 408 is depicted by vector V2 409, and the center of coupler 410 is depicted by vector V3 411. The angle 420 formed by vectors V1 407 and V2 409 is 124.35365000 degrees, the angle 422 formed by vectors V2 409 and V3 411 is 111.29270000 degrees, and the angle 424 between V1 407 and V3 411 is 124.3635000 degrees. FIG. 14 also depicts the relative angles between each vector and a horizontal plane. In FIG. 14 vectors V2 409 and V3 411 are placed in the horizontal plane. In that configuration, the vector V1 forms an angle 426 with the horizontal plane of 18.61000000 degrees. In other words, that angle 426 may be formed with respect to a plane formed by the coupler 409, 411 axes. The angle 426 for one prototype connector was measured by placing two of the couplers into a plane and analyzing the angle formed between the elevated coupling axis and that plane.

Various values are provided for the measured angles, some of which are more precise than necessary to complete a geodesic structure. Thus, while relatively precise measurements are given for the embodiments shown in FIGS. 10-14, in other embodiments the angles may deviate from those exact measurements, and the invention is not limited to the particular embodiments or to the precise measurements shown in FIGS. 10-14. The amount by which the angular values can vary before the connector does not close the structure is dependent on several factors, such as geometrical accuracy, and the accuracy of the machines being used to produce the connector. According to embodiments of the present invention, the angular values between the central axes of the three couplers may vary slightly from one connector to another due to slight variations resulting from the manufacturing process. For example, angular values may vary by plus or minus 0.25 degrees due to those variations

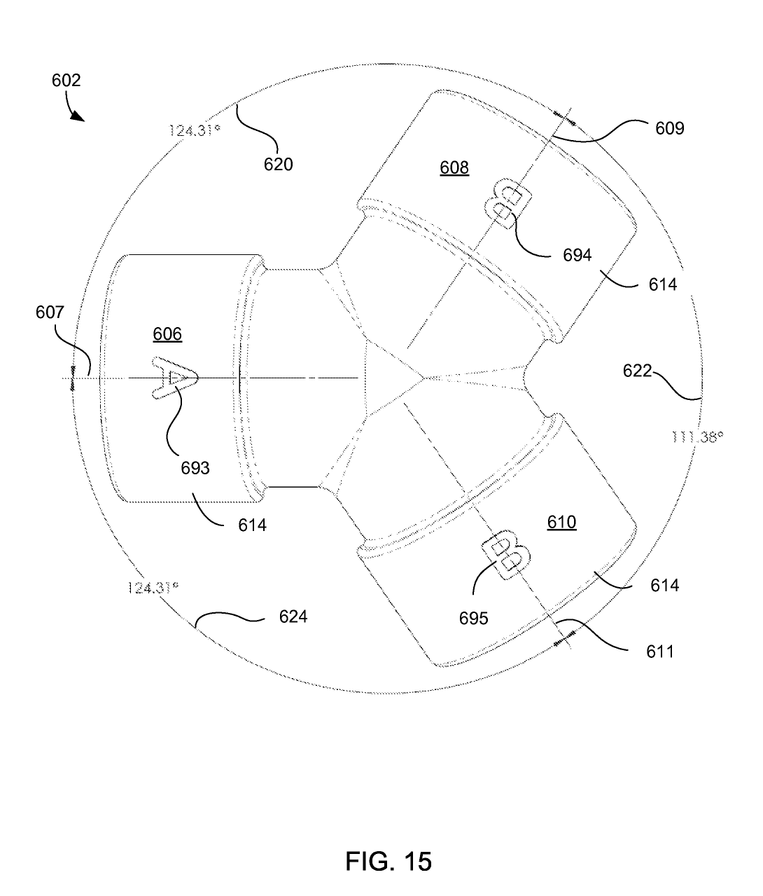

In another embodiment of the present invention, as shown in FIG. 15, a connector 602 comprises a first coupler 606, a second coupler 608, and a third coupler 610. The angle 620 formed between the axial centerline 607 of the first coupler 606 and the axial centerline 609 of second coupler 608 is approximately 124.31 degrees. The angle 624 between the axial centerline 607 of the first coupler 606 and the axial centerline 611 of third coupler 610 is also approximately 124.31 degrees. The angle 622 between the axial centerline 609 of the second coupler 608 and the axial centerline 611 of the third coupler 610 is approximately 111.38 degrees.

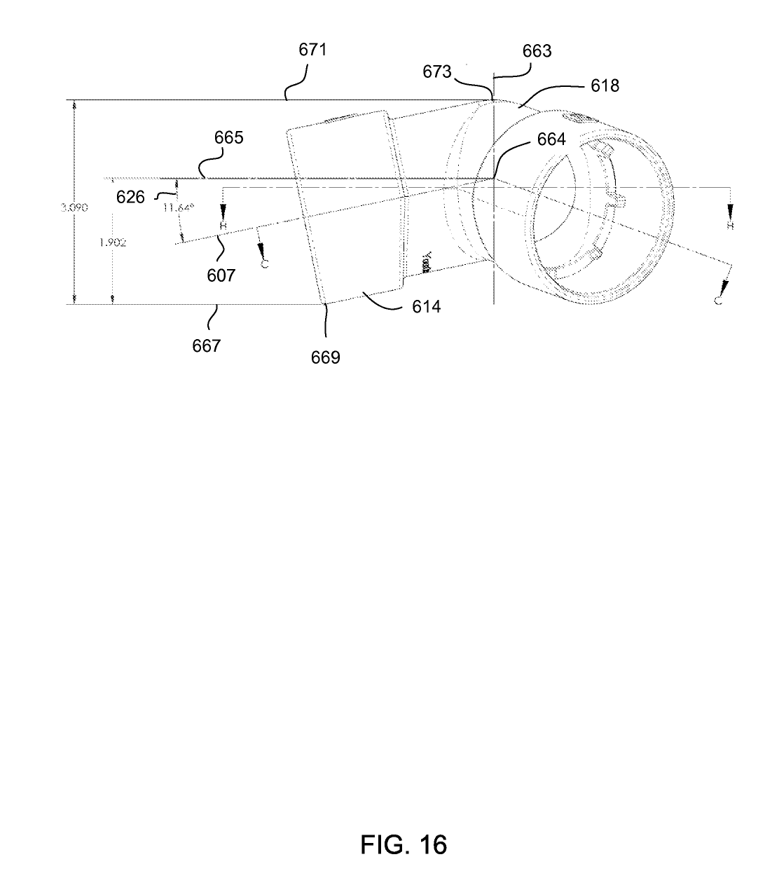

The axial centerlines 607, 609, and 611 intersect at a vertical axis 663, as depicted in FIG. 16. A horizontal plane 665 intersects with the vertical axis 663 at the intersection point 664. Each of the axial centerlines 607, 609, and 611 forms an angle with the horizontal plane 665. FIG. 16 illustrates the angle 626 that is formed between the first axial centerline 607 and the horizontal plane 615. That angle 626 may be 11.64 degrees. The angles formed between the other two axial centerlines 607, 609 and the horizontal plane may also be 11.64 degrees. In those embodiments, a second horizontal plane 667 intersects a bottom point 669 of the coupling ring 614, and the distance between the horizontal plane 665 and the second horizontal plane 667 may be approximately 1.902 inches. A third horizontal plane 671 may intersect a top point 673 of the midpiece 618, and the distance between the second horizontal plane 667 and the third horizontal plane 671 may be approximately 3.090 inches.

Referring back to FIG. 15, the coupler 602 may include three visual elements 693, 694, and 695. Each visual element is located on the top of a coupling ring 614 on a different coupler 606, 608, or 610. The visual elements 693, 694, and 695 may be letters, numbers, colors, or any other visual indicator. The visual elements 693, 694, and 695 may be engraved into the coupling rings 614, may extend from the coupling rings 614, may be attached onto the coupling rings 614, and/or may be printed or etched onto the couplers and/or coupling rings, for example. The visual elements 693, 694, and 695 may identify each coupler in order to facilitate construction of the geodesic structure. In the embodiment shown in FIG. 15, couplers 608 and 610 have identical visual elements 694, 695 as couplers 608 and 610 form identical angles with coupler 606 and a unique angle between themselves.

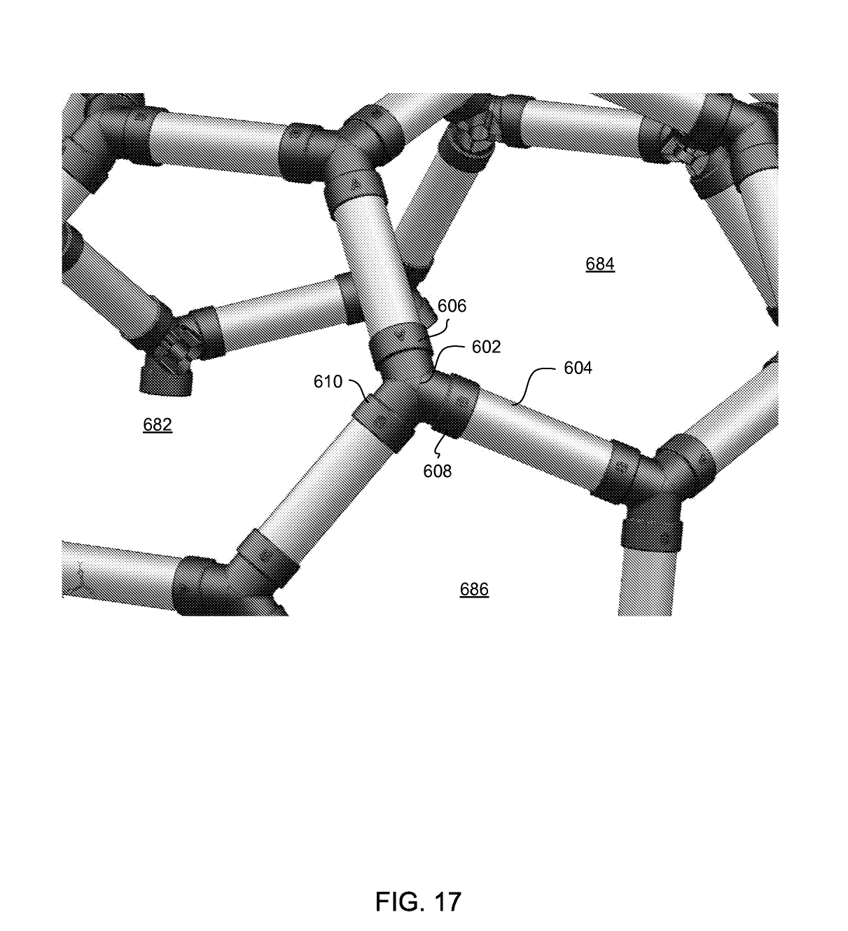

As shown in FIG. 17, a geodesic dome may be formed using a plurality of couplers 602 and straight segments 604. A first end of a first segment 601 is secured to the first coupler 606 of a connector 602. The other end of the first segment 601 is secured to the first coupler 606 of a different connector 602. This forms an “A-to-A” link. The other segments 603, 605 are each secured to the second and third couplers 608, 610 of the connectors 602 to form a “B-to-B” link. When constructing the geodesic dome, each connector and each segment are secured using those two links to form a geodesic structure. In FIG. 17, the first coupler 606, the midpiece 618, and the second coupler 608 form a vertex of a hexagon 682. In addition, the first coupler 606, the midpiece 618, and the third coupler 610 also form a vertex of a hexagon 684. The second coupler 608, the midpiece 618, and the third coupler 610 form a vertex of a pentagon 686. The axial centerlines 607, 609, 611 of the couplers 606, 608, 610 each form an angle of approximately 11.64 degrees with a horizontal plane.

As discussed above, those angular configurations may vary. For example, each angle may deviate by plus or minus 0.25 degrees due to mechanical variations. In addition, other embodiments may use angles 620, 622, 624, and 626 that deviate in varying degrees from the embodiment discussed above. For example, in one embodiment each angle 620, 622, 624, or 626 may vary by plus or minus 0.25 degrees. In another embodiment, each angle 620, 622, 624, or 626 may vary by plus or minus 0.50 degrees. Other embodiments employ angles 620, 622, 624, or 626 that may vary by plus or minus one degree. Still other embodiments employ angles 620, 622, 624, or 626 that may vary by plus or minus two degrees. Some embodiments employ angles 620, 622, 624, or 626 that may vary by plus or minus three degrees; some embodiments employ angles 620, 622, 624, or 626 that may vary by plus or minus four degrees; some embodiments employ angles 620, 622, 624, or 626 that may vary by plus or minus five degrees; some embodiments employ angles 620, 622, 624, or 626 that may vary by plus or minus six degrees; some embodiments employ angles 620, 622, 624, or 626 that may vary by plus or minus seven degrees; some embodiments employ angles 620, 622, 624, or 626 that may vary by plus or minus eight degrees; some embodiments employ angles 620, 622, 624, or 626 that may vary by plus or minus nine degrees; and some embodiments employ angles 620, 622, 624, or 626 that may vary by plus or minus ten degrees. In many of those embodiments, the angles 626 formed between each axial centerline and the horizontal plane may vary less than the angles 620, 622, and 624 formed between each axial centerline. In those embodiments, a geodesic structure may be constructed using a plurality of identical connectors 602 and segments 604, and the size of a geodesic structure may be varied simply by altering the length of the straight segments 604.

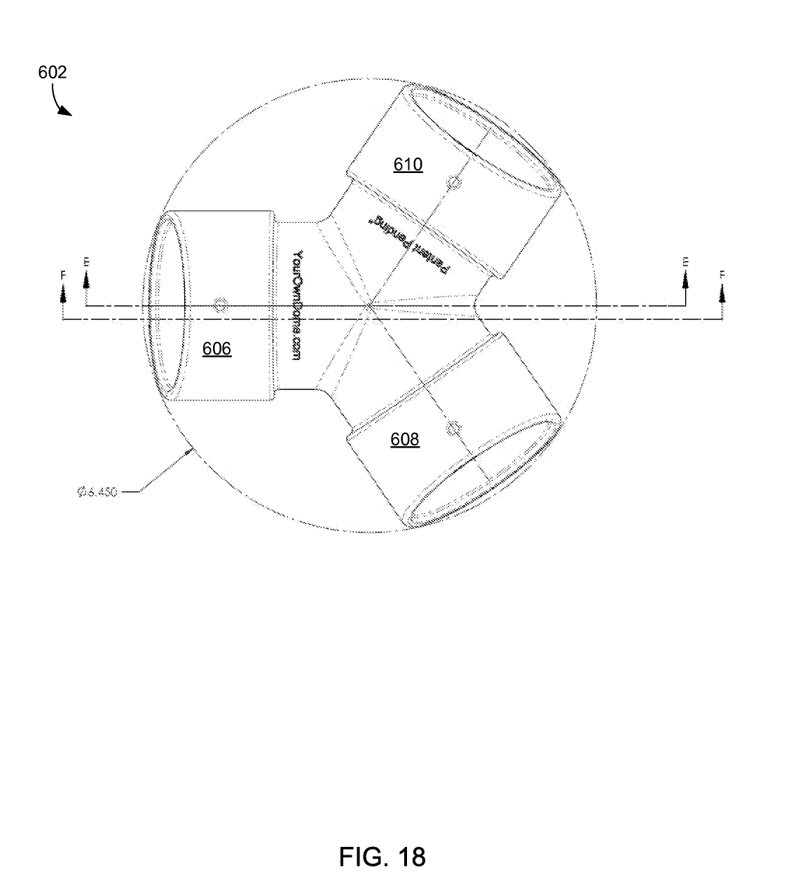

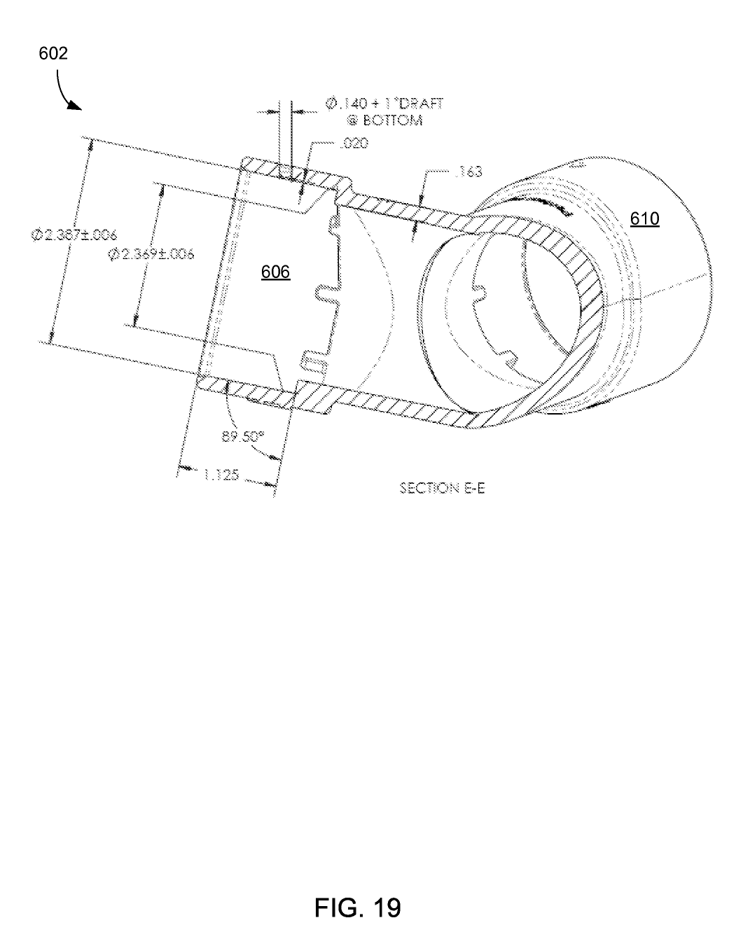

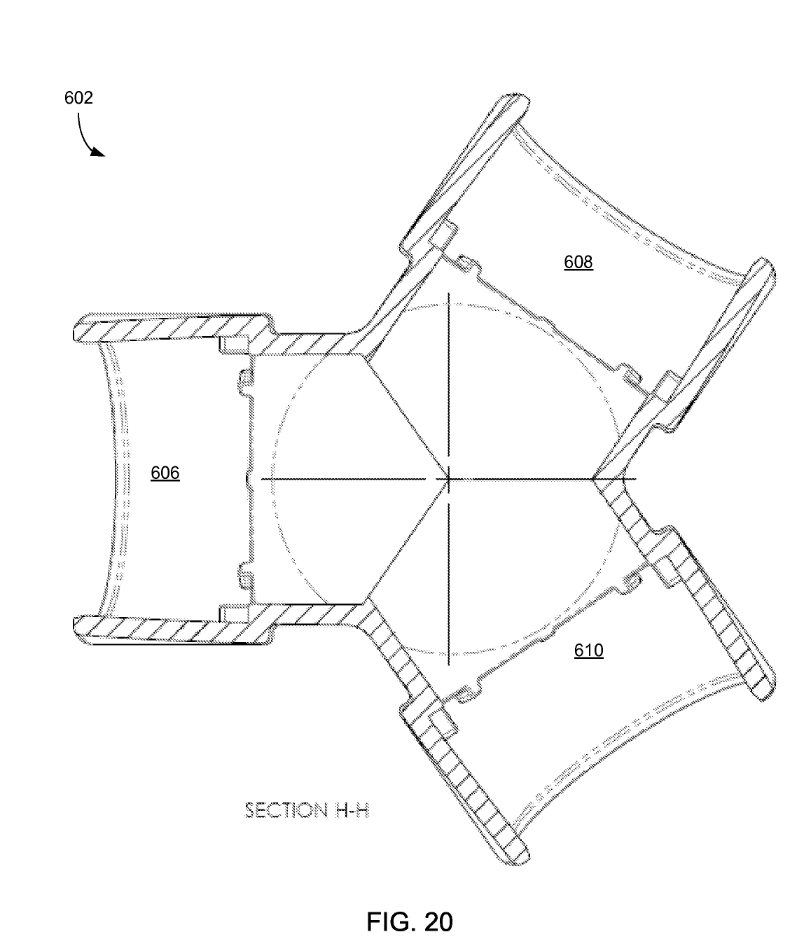

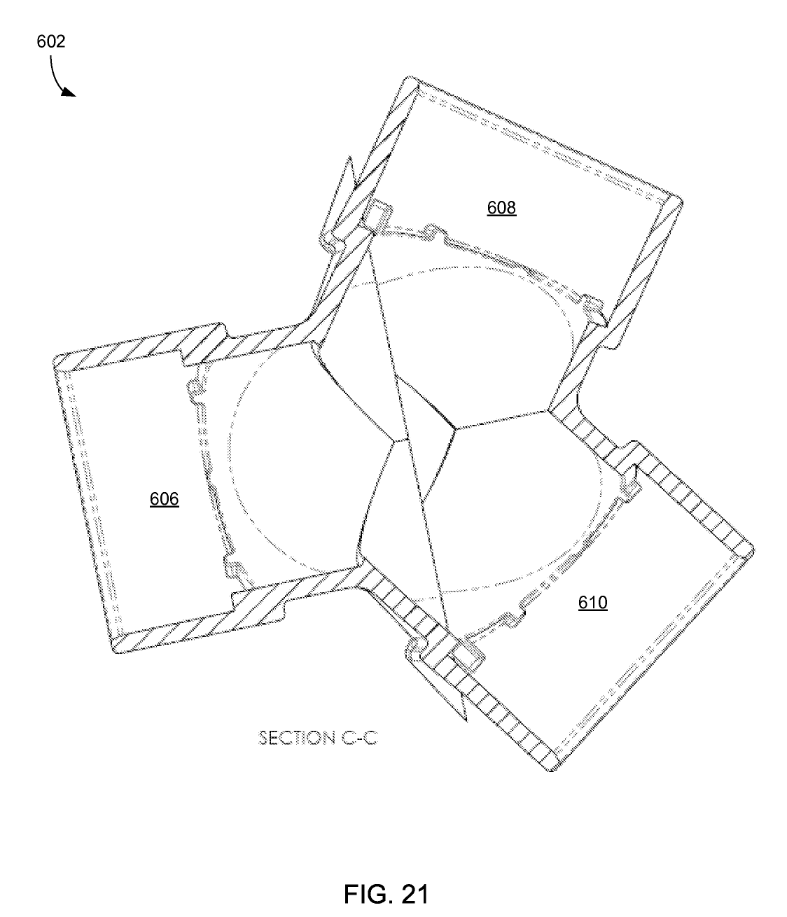

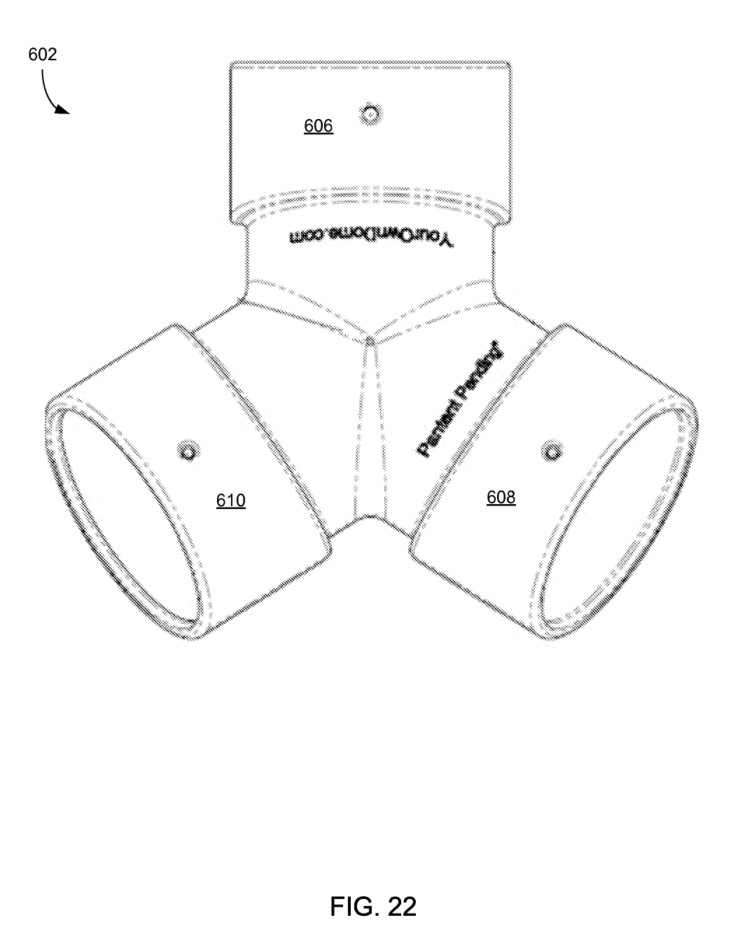

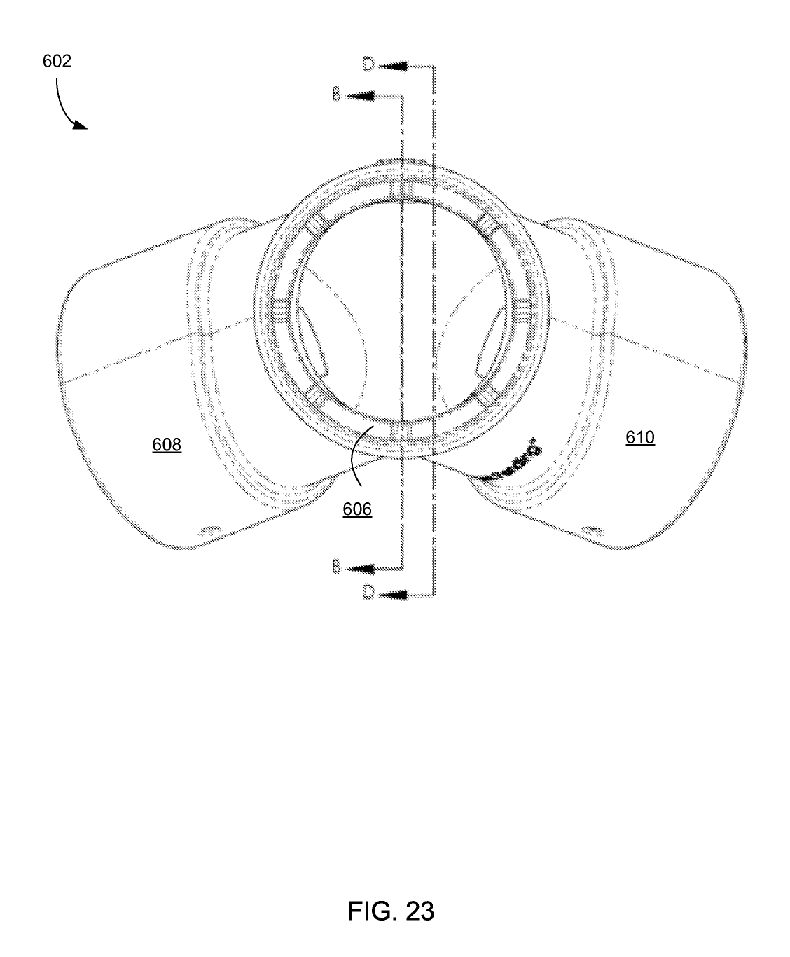

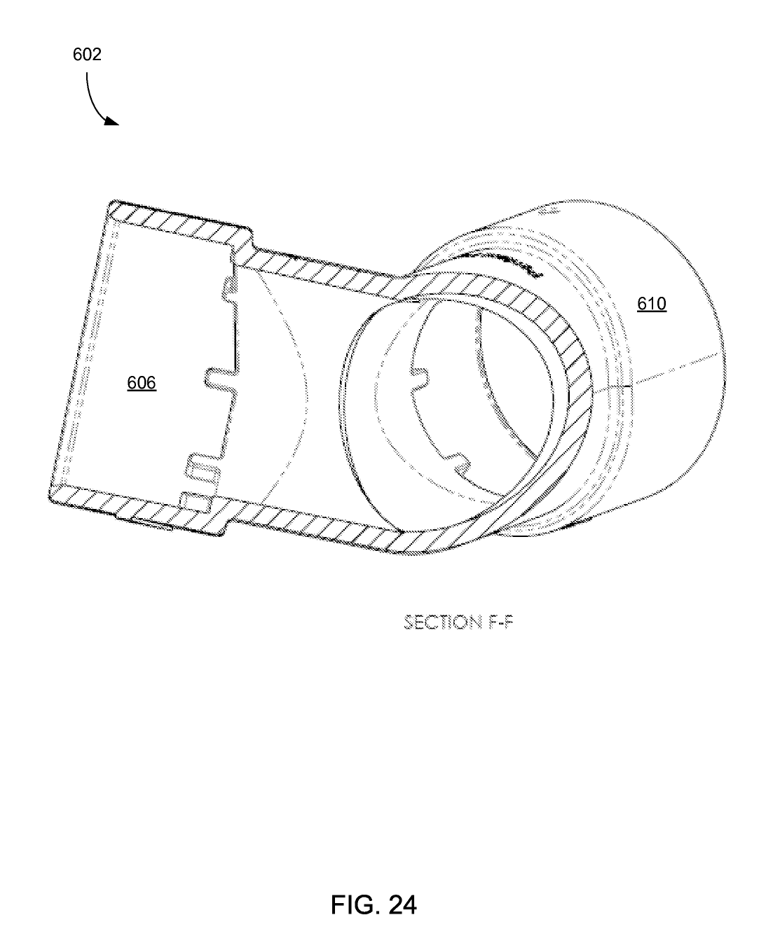

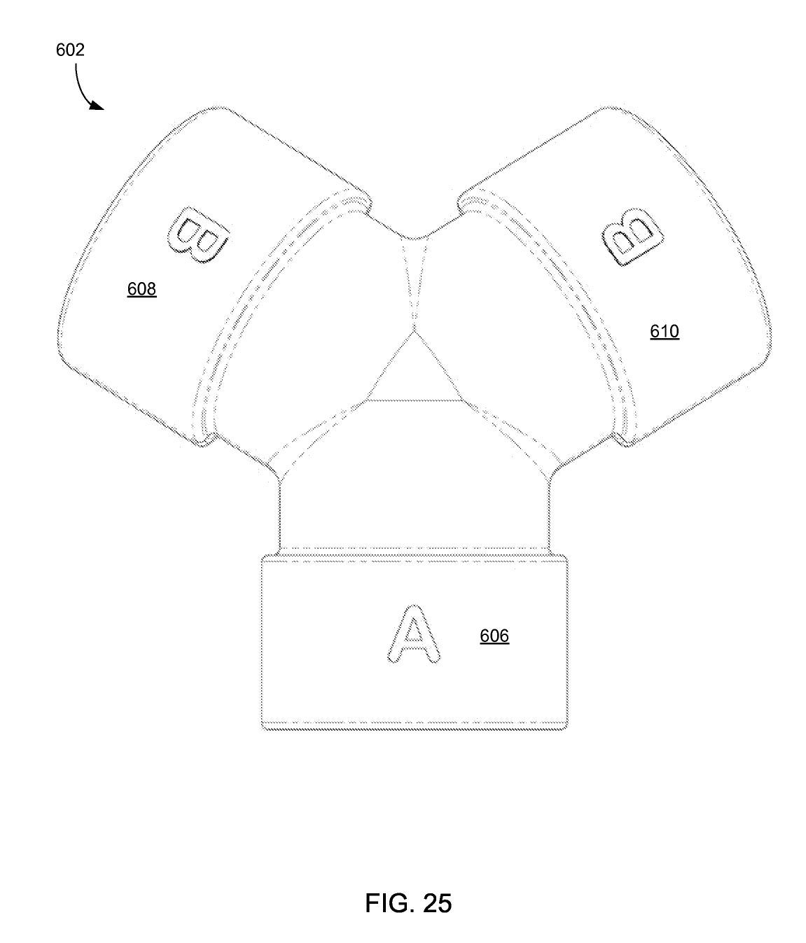

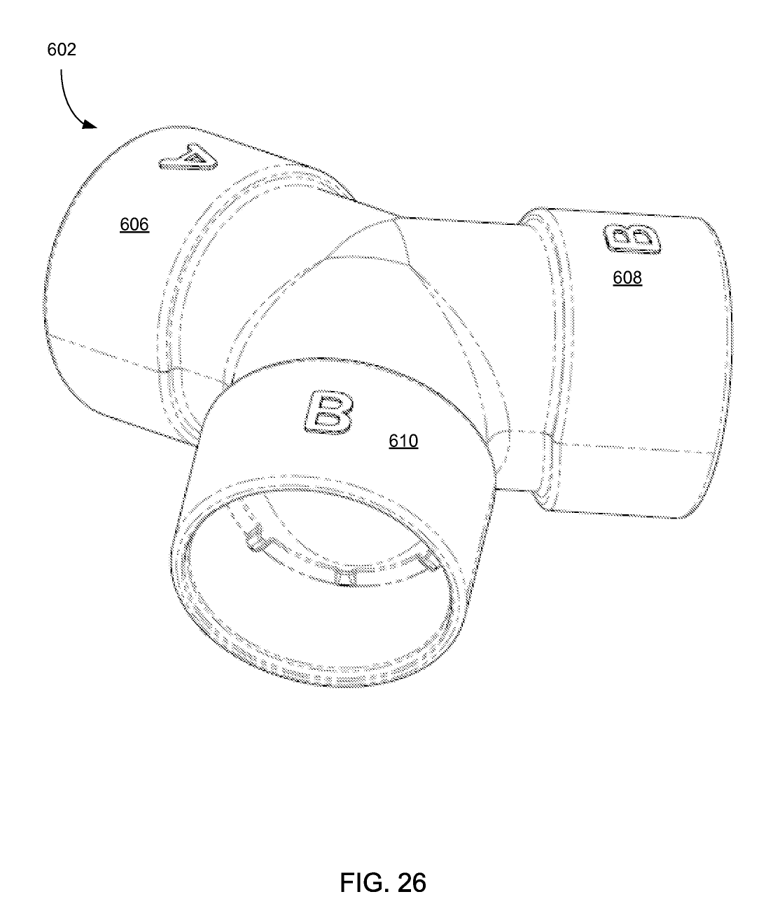

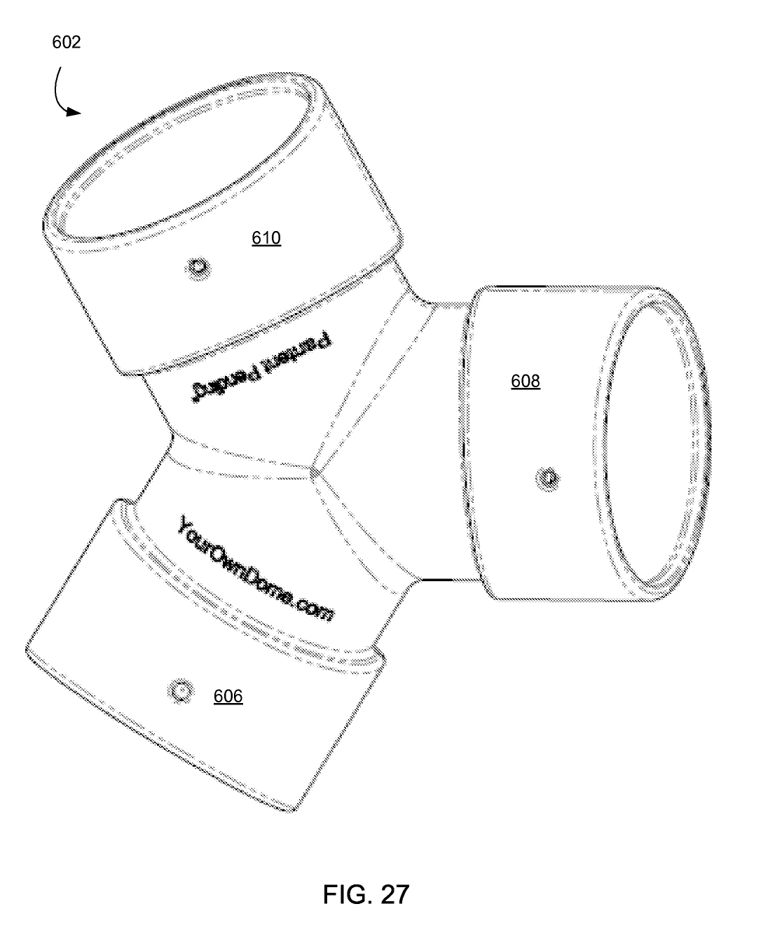

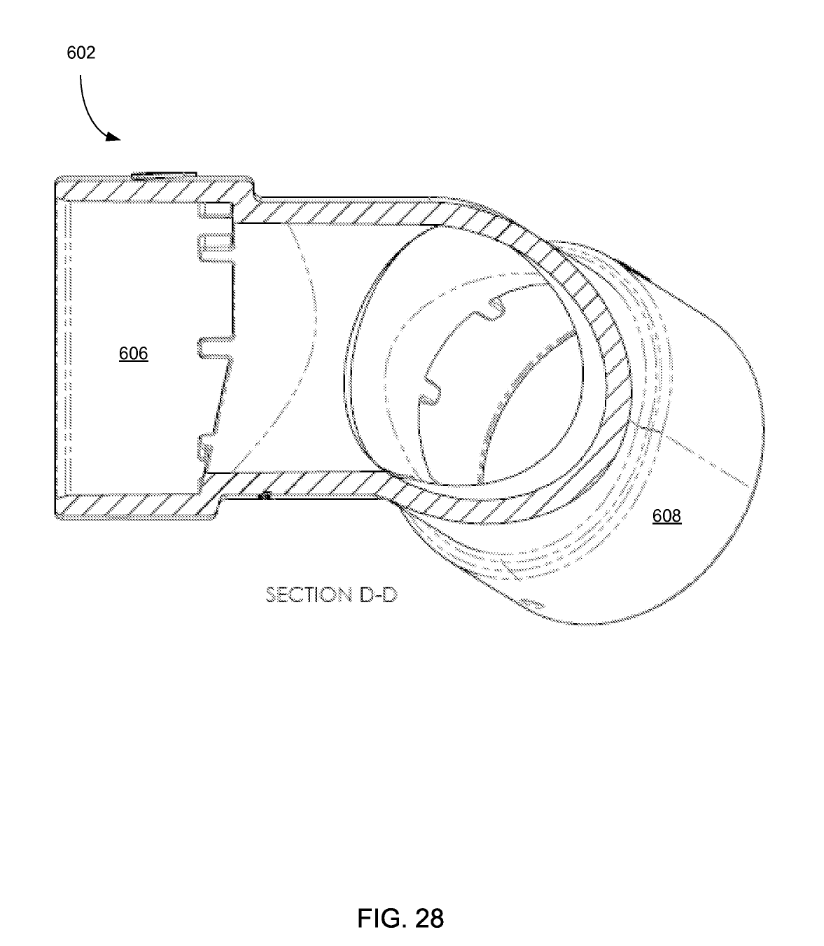

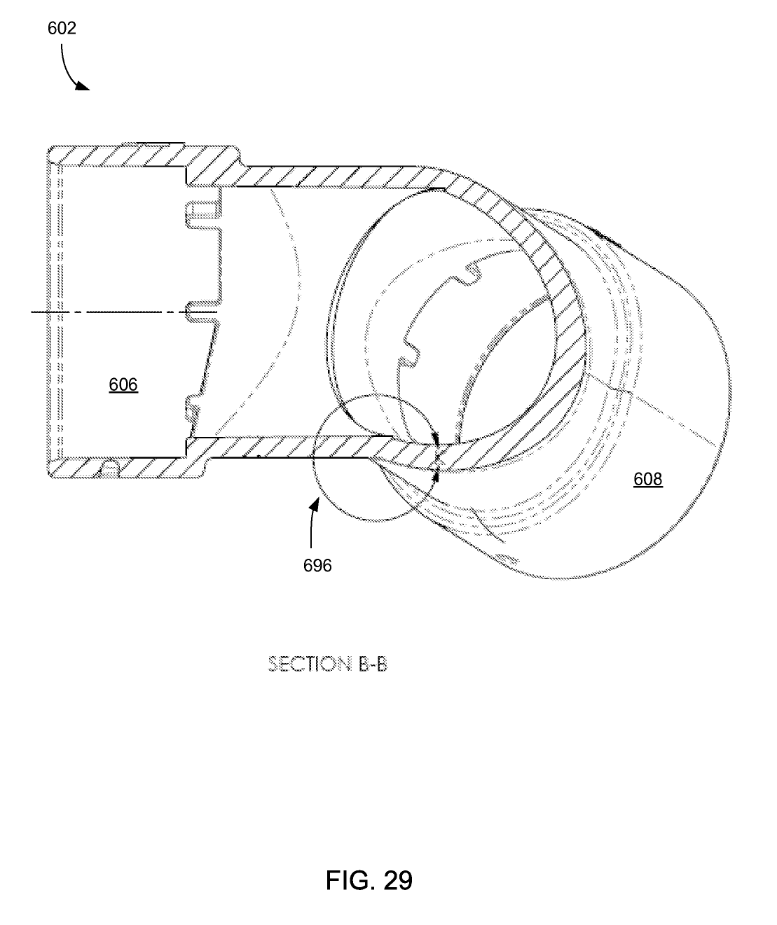

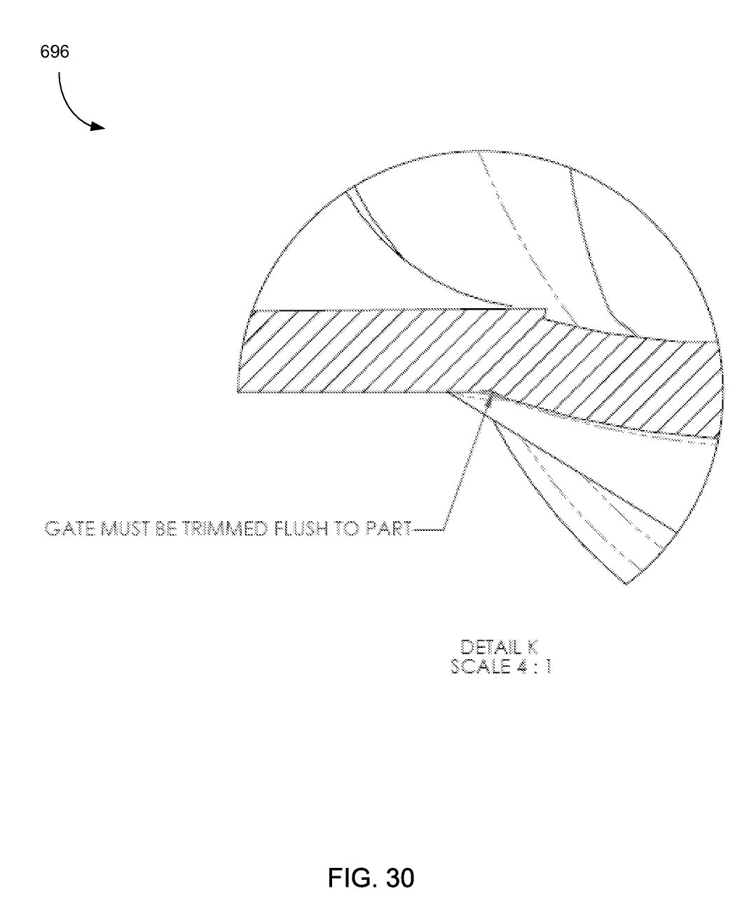

FIGS. 18-30 illustrate various views of the coupler 602. FIGS. 29 and 30 focus on the intersection of couplers 606 and 608 at a junction 696.

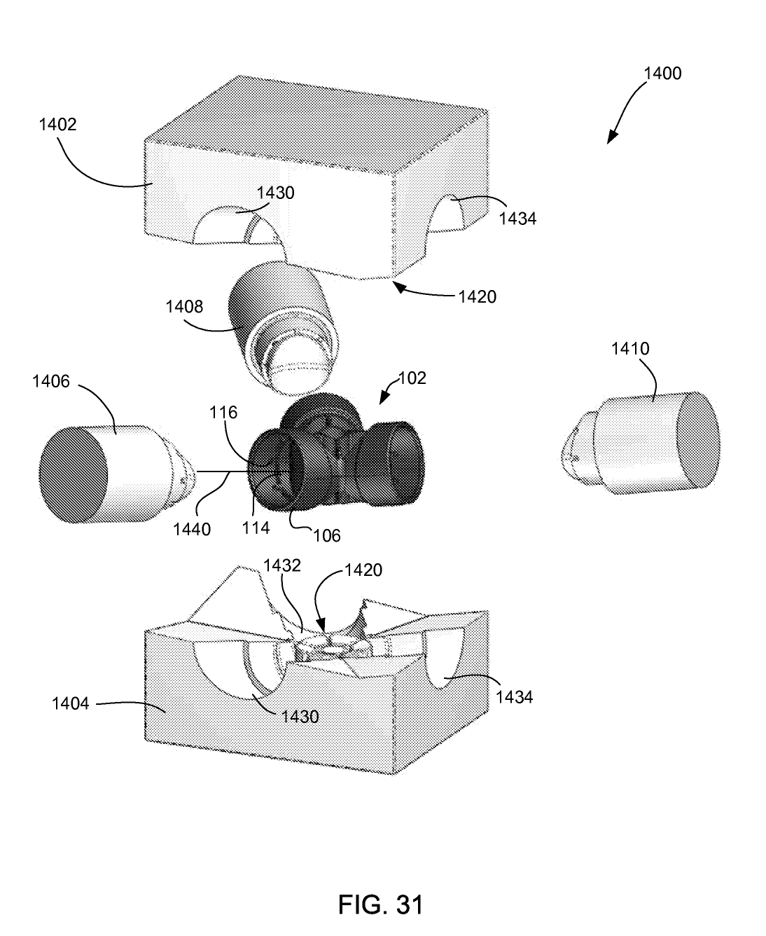

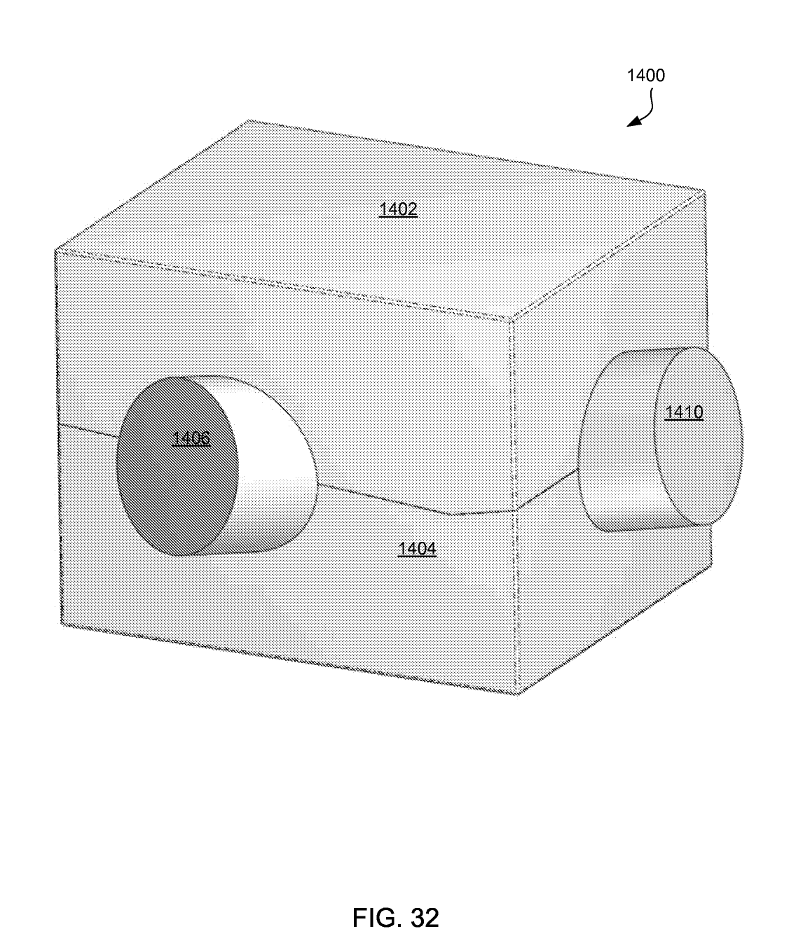

FIGS. 31 and 32 illustrate a mold 1400 that may be used to create a connector 102 according to embodiments of the present invention. As shown in FIG. 31, the mold comprises a top component or half 1402, a bottom component or half 1404, and cores 1406, 1408, and 1410. The top component 1402 and the bottom component 1404 include the negative of the outside of the connector 102, and may include protrusions 1420 to mold particular midpiece apertures. The cores 1406, 1408, and 1410 include the negative of the coupler apertures 112, which may include the coupler ring 114 and coupling protrusions 116. In that manner, the connector 102 may be formed by injection molding so that it may be formed as a single unitary piece of material. In the molding process, the mold halves 1402, 1404 are closed together and optionally compressed together, and the cores 1406, 1408, and 1410 are advanced into their respective channels 1430, 1432, 1434. The molding material, for example ABS or PVC plastic, is then injected into the spaces between the mold halves 1402, 1404 and the cores 1406, 1408, 1410 to form a connector 102. According to some embodiments, the direction in which each core 1406 advances in and out of the channel in the mold halves 1402, 1402 is aligned with the axial centerline 1440 of each coupler 106 formed on the connector 102.

In other embodiments, the connectors 102 may be formed to match segments 104 of a particular size. For example, if the ends of a segment 104 are approximately four inches in diameter, then the connectors 102 would be formed to match. In other embodiments, the connector may match segments of varying length or diameter. While in some embodiments the connectors correspond to cylindrical segments, in other embodiments the connectors are configured to attach to segments having rectangular, triangular, and/or other cross sectional shapes.

In some embodiments, the segments 104 may be straight segments. In some embodiments, the segments 104 or connectors may take on a variety of shapes and configurations. For example, a segment 104 may be irregularly shaped, e.g., may include one or more bends, kinks, knots, or twists. In addition, the segments 104 may be flexible or inflexible according to specific applications. A segment 104 may be substantially rigid. Furthermore, the segments 104 may include gaps, holes, or discontinuities. For example, the segment or connectors may include a set of holes through which clips or hooks are attached, allowing a user to hang or connect items to the geodesic dome, or a set of discontinuities in the segments may form an aperture or doorway in the geodesic dome. In some embodiments, each end of the segment 104 may be straight and co-linear, such that the geodesic dome may be constructed with a plurality of identical connectors 102 and identical segments 104.

In other embodiments, both the connectors 102 and the segments 104 may be hollow or contain hollow channels, such that a wire, cord, or other materials may be placed throughout the geodesic dome. Some embodiments of connector 102 also include segments having apertures, such that the materials placed within the segment may be accessed through the apertures. Similar apertures may be found on the connectors, or the midpiece apertures may be configured to provide access to the element.

The geodesic dome, according to some embodiments, may be easily tailored for particular projects. For example, if a tall structure is needed, the connectors and segments may be quickly assembled. The height and/or size of a geodesic dome may be customized by omitting or including additional sets of segments at the bottom layer of the dome. For example, using twenty to fifty connectors a user can construct structures of sizes such as one quarter of a sphere, three-eighths of a sphere, a hemisphere, or five-eighths of a spherical dome. The connectors are interchangeable, and in some embodiments may form a geodesic dome having pentagons surrounded by hexagons. In those embodiments, a sixty unit assembly will constitute a complete sphere. If a simple perimeter is desired, for example a fence, then portions of the dome may be omitted. For applications where the geodesic dome acts as a shelter, a cover such as canvas or plastic may be placed over the dome.

Geodesic domes formed according to embodiments of the present invention are able to bear loads of approximately 100 pounds per square foot and are also able to withstand wind speeds of approximately 140 miles per hour. In those embodiments in which the segments or connectors have holes and/or cords, such features can be used to secure the cover to the dome. Using similar or identical components for the dome allows for easy replacement of broken or lost parts, as well as facilitating the completion of unique, individually-tailored structures.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

1. A plurality of connectors for a geodesic dome, each of the plurality of connectors comprising:
a first coupler configured to couple with a first segment of a plurality of segments;
a second coupler coupled with the first coupler and configured to couple with a second segment of the plurality of segments; and
a third coupler coupled with the first and second couplers and configured to couple with a third segment of the plurality of segments,
wherein the first coupler has a first central axis, the second coupler has a second central axis, and the third coupler has a third central axis, and wherein the first, second, and third central axes intersect at a vertical axis;
wherein in a horizontal plane orthogonal to the vertical axis, a first angle is formed between the first and second central axes, a second angle is formed between the second and third central axes, and a third angle is formed between the third and first central axes;
wherein a fourth angle is formed between the first central axis and the horizontal plane, a fifth angle is formed between the second central axis and the horizontal plane, and a sixth angle is formed between the second central axis and the horizontal plane; and
wherein the first, second, third, fourth, fifth, and sixth angles are configured to permit coupling of the plurality of connectors and the plurality of segments to form the geodesic dome.

2. The plurality of connectors of claim 1, wherein the first angle is 124.31 degrees, the second angle is 124.31 degrees, and the third angle is 111.38 degrees.

3. The plurality of connectors of claim 2, wherein the fourth angle, the fifth angle, and the sixth angle are each 11.64 degrees.

4. The plurality of connectors of claim 1, wherein the first angle and the second angle each has a value from 124.06 degrees to 124.56 degrees and the third angle has a value from 111.13 degrees to 111.63 degrees.

5. The plurality of connectors of claim 1, wherein the first angle and the second angle each has a value from 123.31 degrees to 125.31 degrees and the third angle has a value from 110.38 degrees to 112.38 degrees.

6. The plurality of connectors of claim 1, wherein the fourth angle, the fifth angle, and the sixth angle each has a value from 11.54 degrees to 11.74 degrees.

7. The plurality of connectors of claim 1, wherein the fourth angle, the fifth angle, and the sixth angle each has a value from 11.39 degrees to 11.89 degrees.

8. The plurality of connectors of claim 4, wherein the fourth angle, the fifth angle, and the sixth angle each has a value from 11.39 degrees to 11.89 degrees.

9. The plurality of connectors of claim 1, wherein the first coupler comprises a first circular aperture configured to receive the first segment, the second coupler comprises a second circular aperture configured to receive the second segment, and the third coupler comprises a third circular aperture configured to receive the third segment.

10. The plurality of connectors of claim 1, wherein the first coupler comprises a first inner surface having at least one first inner surface protrusion, the second coupler comprises a second inner surface having at least one second inner surface protrusion, and wherein the third coupler comprises a third inner surface having at least one third inner surface protrusion.

11. The plurality of connectors of claim 1, further comprising a midpiece coupled to the first coupler, the second coupler, and the third coupler, wherein the midpiece comprises a plurality of midpiece apertures.

12. The plurality of connectors of claim 11, wherein the plurality of midpiece apertures includes at least one center midpiece aperture and at least one side midpiece aperture.

13. The plurality of connectors of claim 1, wherein the midpiece comprises a hollow channel.

14. A mold for a connector for a geodesic dome, wherein the mold comprises a negative of:
a first coupler configured to couple with a first segment of a plurality of segments;
a second coupler coupled with the first coupler and configured to couple with a second segment of the plurality of segments; and
a third coupler coupled with the first and second couplers and configured to couple with a third segment of the plurality of segments,
wherein the first coupler has a first central axis, the second coupler has a second central axis, and the third coupler has a third central axis, and wherein the first, second, and third central axes intersect at a vertical axis;
wherein in a horizontal plane orthogonal to the vertical axis, a first angle is formed between the first and second central axes, a second angle is formed between the second and third central axes, and a third angle is formed between the third and first central axes;
wherein a fourth angle is formed between the first central axis and the horizontal plane, a fifth angle is formed between the second central axis and the horizontal plane, and a sixth angle is formed between the second central axis and the horizontal plane; and
wherein the first, second, third, fourth, fifth, and sixth angles are configured to permit coupling of a plurality of connectors formed by the mold and the plurality of segments to form the geodesic dome.

15. The mold of claim 14, further comprising a first core configured to create a first aperture in the first coupler, a second core configured to create a second aperture in the second coupler, and a third core configured to create a third aperture in the third coupler.

16. The mold of claim 14, wherein the first angle and the second angle each has a value from 124.06 degrees to 124.56 degrees and the third angle has a value from 111.13 degrees to 111.63 degrees.

17. The mold of claim 14, wherein the fourth angle, the fifth angle, and the sixth angle each has a value from 11.54 degrees to 11.74 degrees.

18. A method of making a geodesic structure, comprising:
coupling a plurality of segments with a plurality of connectors, wherein each connector comprises:
a first coupler configured to couple with a first substantially straight segment of the plurality of substantially straight segments;
a second coupler configured to couple with a second substantially straight segment of the plurality of substantially straight segments; and
a third coupler configured to couple with a third substantially straight segment of the plurality of substantially straight segments,
wherein the first coupler includes a first centerline, the second coupler includes a second centerline, and the third coupler includes a third centerline, and wherein a first angle is formed between the first centerline and the second centerline, a second angle is formed between the second centerline and the third centerline, and a third angle is formed between the first centerline and the third centerline, and
wherein a fourth angle is formed between the first centerline and a horizontal plane, a fifth angle is formed between the second centerline and the horizontal plane, and a sixth angle is formed between the third centerline and the horizontal plane.

19. The method of claim 18, wherein the first angle and the second angle each has a value from 124.06 degrees to 124.56 degrees, the third angle has a value from 111.13 degrees to 111.63 degrees, and the fourth angle, the fifth angle, and the sixth angle each has a value from 11.54 degrees to 11.74 degrees.

20. The method of claim 18, wherein the first coupler comprises a first visual indicator, wherein the second coupler comprises a second visual indicator the same as the first visual indicator, and wherein the third coupler comprises a third visual indicator different from both the first and second visual indicators, the method further comprising: connecting with segments only those couplers sharing a common visual indicator.

21. The method of claim 20, wherein the first, second, and third visual indicators are each selected from the group consisting of a letter, a number, a color, a shape, and a symbol.
